(19) United States
(12) Patent Application Publication
(10) Pub. No.: US 2006/0090959 A1
(43) Pub. Date: May 4, 2006

(54) Devices and transducers with cavity resonator to control 3-D characteristics/harmonic frequencies for all sound/sonic waves

(75) Inventor: Daniele Ramenzoni, Fidenza (Parma) (IT)

Correspondence Address: HEDMAN & COSTIGAN P.C., 1185 AVENUE OF THE AMERICAS, NEW YORK, NY, 10036, US

(73) Assignees: Andrea Chiesi; Gianandrea Bianchi

(21) Appl. No.: 11/250,053

(22) Filed: Oct. 13, 2005

(30) Foreign Application Priority Data
Oct. 18, 2004 (IT) MI2004A001972

(51) Int. Cl. E04B 1/82; H04R 1/02

(52) U.S. Cl. 181/292; 381/345

(57) ABSTRACT

The invention concerns an acoustic device (and its electric/electronic circuits) with electro-acoustic transducers and with a cavity resonator that provide extreme tri-dimensional characteristics (in order to control the main harmonic frequencies but also the fundamental harmonic in the harmonic series) to concentrate/diffuse infrasonic, sonic and ultrasonic waves. It also concerns many structural designs in which some models of cavity resonators and all their transducers are appropriately arranged and spatially aligned on the basis of the different uses; so doing it is possible to achieve numerous interacting operational set-ups (basic configuration systems) that can be used in the medical sector, in industry or in the home, in entertainment and leisure. Differently to previously known techniques the acoustic device according to this patent is also a highly sophisticated cybernetic apparatus for the reproduction of various tri-dimensional sound fields that are identical to the original ones, or for generating completely new ones. This acoustic device can be compared to a Helmholtz resonator that transmits sound-waves/harmonic frequencies rather than receiving them.

### TECHNICAL FIELDS OF THE INVENTION

The invention concerns an acoustic device (and its electric/electronic circuits) with electro-acoustic transducers and with a cavity resonator that provide extreme tri-dimensional characteristics (in order to control the main harmonic frequencies but also the fundamental harmonic/overtone in the harmonic series) to concentrate/diffuse infrasonic, sonic and ultrasonic waves. It also concerns many structural designs in which some models of cavity resonators and all their transducers are appropriately arranged and spatially aligned on the basis of the different uses; so doing it is possible to achieve numerous interacting operational set-ups (basic configuration systems) that can be used in many different fields (e.g.: in the medical sector, in industry or in the home, in entertainment and leisure) as illustrated for reference purposes, but in no way restrictive, in the enclosed drawing sheets.

This extremely versatile acoustic device is also a highly sophisticated cybernetic apparatus for the reproduction of various tri-dimensional sound fields that are identical to the original ones, or for generating completely new ones. From these various sound fields, different forms of environmental/surround listening can be obtained, always compatible with the binaural human perception of sound.

This cybernetic apparatus is able to perfectly emulate with superior performances the functions of the human larynx: phonation (the formation of sounds) and respiration (pressure changes and air movements). It is perfectly able to produce beneficial and therapeutic effects on human tissues and human cells that are affected by serious illnesses. The therapeutic effect is not produced from the electro-acoustic energy used but from precise wavelengths (principally from the main harmonic frequencies but also from pure sounds, fundamental harmonics/overtones or first partial) necessary to operate adequately on the ailment.

It is effective due to the stimulating effect it achieves in reactivating and boosting particular brain waves, revealing the acoustic device suitable therefore for the treatment of patients who have trouble or disorder in the production of brain-waves.

The correlation between a stimulus coming from the outside and the patients' own brain waves comes from a theory that is known and proved; this apparatus produces its effect through resonance with delta (δ), theta (τ), alpha (α) and beta (β) brain waves in the frequency band between 0.1 Hz and 30.0 Hz.

The device according to the invention is based on three algorithms: one simulates the two basic components of sound energy with great precision; another emulates and boosts certain phonation characteristics; the third is an algorithm that interacts with the structure of the human brain.

Therefore this acoustic device cannot (in any way) be compared to other existing technologies or other sound systems that derive from mathematical calculations and simulations of environmental acoustic characteristics (i.e.: phase retardation, time delay or experimental tests on sound diffusion through the air in every type of environment).

### BACKGROUND ART OF THE INVENTION AND INTRODUCTION TO THE PARTICULAR CHARACTERISTICS OF THIS DEVICE

In the state of the art of electro-acoustic devices the following patents are cited as reference: KR 158885; DE 3925919; KR 1074076; GB 830281; U.S. Pat. No. 6,175,489; EA 2097; JP 57203398; SU 1663791. None of these present analogies, similar characteristics or similar performances; neither are they even vaguely comparable to the acoustic device described in this patent.

In relation to the connection of this device to other devices, with the function of loudspeaker/s, the following patents are cited as reference: JP 2000004983 and TW 514501.

In relation to electro-medical use of this acoustic device the following patents are cited as reference: U.S. Pat. No. 6,060,293; JP 2001190698; CN 1398141; RU 2162721.

Differently to previously known techniques (including those cited as reference), this will become clearer further on, the acoustic device according to this patent, and the basic configuration systems relative to it, make up a cybernetic apparatus among the most sophisticated available today for the reproduction/transmission of sound fields identical to the original (in an extremely realistic/accurate way). The main qualities of the cavity resonator, in the inventive device, are that it works in the same manner as a Helmholtz resonator but, instead of receiving sound/harmonic frequencies, it transmits/diffuses them with their harmonic series. In the inventive device the sonic waves (including infrasonic and ultrasonic waves) and their harmonic series move in a contrary way in respect to the Helmholtz resonator.

It is known that, in the 19^{th} century, Hermann Ludwig Ferdinand von Helmholtz (1821-1894) in his research used hollow brass spheres and hollow spherical glass bulbs of various diameter with two diametrically opposite tubular openings: the larger opening was directed towards the sound source to be analysed and the smaller opening was held close to the ear with the better hearing. This instrument was given its inventor's name and is still known today as the “Helmholtz resonator”.

In a Helmholtz resonator the sound generated at the source (original sound source) follows a precise route through the two openings of the resonator in order to reach the ear (like a receiver), whilst in the cavity resonator of the inventive device the sound/harmonic frequencies go in the opposite direction (like a transmitter) to recreate their original sound source outside the inventive device. In this cavity resonator the wavelengths (this applies to the whole range of wavelengths) choose their route through two openings diametrically opposite each other (see FIGS. 3/a and 4/a) in order to reach their point of origin (to recreate the original sound source). The direction which is automatically chosen, above all by the harmonic frequencies (rather than the fundamental harmonic) will always be the opposite of that in a typical Helmholtz resonator.

As mentioned above, in the Helmholtz resonator sound proceeds leaving from an entry opening in order to reach an exit opening (near the ear); vice-versa, in the inventive device the sound/harmonic frequencies (with their fundamental harmonics) travelling in the opposite direction: the whole series of harmonic frequencies (but also the fundamental harmonic/overtone) is created inside the cavity resonator (301, 407, 413, 415) by simply inverting the two voltage feeders (positive pole and negative pole) of the power supply of the fixed solenoid/s (201, 209, 217, 231, 239) of one of the two electro-dynamic drivers (403) that are set opposite each other (in this case the lines of force of the electromagnetic fields generated by the two drivers will be all orientated in the same direction). A similar effect can be obtained by simply inverting the two feeders (inverting the phase) of the electrical input signal of one of the two moving/vibrating coils (243; also see FIGS. 5/b-c) in one of the two drivers that are situated opposite one another at 180° at the two extremities of the cavity resonator. This second solution (the inversion of the phase/feeders of the electrical input signal that supplies one of the moving/vibrating coils) is the only one that works when the magnetic fields of the drivers are generated by permanent magnets only (magneto-dynamic drivers; e.g.: 307 and 417).

It is also possible to have applications (FIG. 6/a Sheet 6/6) where each pair of moving/vibrating coils forms an angle of 90° (e.g.: Front with Left, and/or Rear with Right).

### SUMMARY OF THE INVENTION

The main aim of this acoustic device is to supply sound transducers that can be conveniently used to generate, control, concentrate/diffuse infra-sounds, sounds and ultrasounds, with the added advantage of being able to direct sound fields, sonic waves, shock waves, acoustic signals, pure sounds, harmonic frequencies, fundamental harmonics, overtones, first partial towards precise points or targets (FIG. 5/e).

A second aim is to supply a device that enables the listening/reception of harmonic frequencies, fundamental harmonics/overtones through vibrations/reflections, making them interact with materials. In this case the device offers the advantage of transforming a prefixed percentage of acoustic energy into vibrations/reflections and/or into pressure changes and air movements, due to this the peak of amplitude of precise wavelengths produces resonating effects on the objects it hits (FIG. 5/d). Furthermore medicines/drugs, food products and industrial materials can be analysed and selected by varying the frequency, amplitude (level of penetration) of the sound waves/harmonic frequencies.

A third aim is to supply a device (with relative cavity resonator) designed to interact in a specific way with air particles, water molecules, plant and animal cells, but above all with living human cells for therapeutic and diagnostic means (FIG. 4/b).

A fourth aim is that of supplying devices with low production costs in order to associate them with objects/appliances for everyday use.

A fifth aim is that of supplying a small device (even extremely small) able to produce a clearly superior sound output in comparison with traditional devices of equal dimensions already in use today.

Another aim of this device is that of supplying cybernetic applications (see examples: FIGS. 5/a-b-c) with the function of emulating and boosting several characteristics of the human voice (both male and female).

A further aim of the invention is to supply a device where the cavity resonator and its transducers can be “tuned” during assembly in order to transmit different mechanical vibrations/resonance effects at accurately predetermined (harmonic) frequencies.

All of these aims and more (that have not been mentioned) are achieved by the (electro-) acoustic device according to the invention, capable of operating in the atmosphere and under extreme conditions (also in the presence of water, vapour or gases, and in water, by applying certain known precautions) without going beyond the protective remit of this patent, as described, illustrated and claimed further on in this document by the specified aims.

### BRIEF DESCRIPTION OF THE SHEETS AND DRAWINGS

SHEET 1/6

Three diagrams of the same curve are shown (FIGS. 1/a, 1/b, 1/c) on different scales between the abscissa (x) axis and the ordinate (y) axis. Starting with orderly pairs of numbers on the plane (ρ,θ): the first diagram (FIG. 1/a) shows the initial part (101) of the typical curve; the second diagram (FIG. 1/b) shows the constant velocity (k) of point (P) on the spiral (131, 133, 135); the third diagram (FIG. 1/c) shows the position where the spiral has been interrupted (161).

SHEET 2/6

An example of electro-dynamic driver shown by three drawings (FIGS. 2/a, 2/b, 2/c): with various electric coils/fixed solenoids (201, 209 and 217 in FIG. 2/a); where the electromagnetic circuit is schematised (FIG. 2/b), and with the sections of various fixed coils/solenoids (201, 231 and 239); with the exponential loudspeaker (acoustic radiator/diffuser) added to the electro-dynamic driver (FIG. 2/c).

SHEET 3/6

First example in section (FIG. 3/a) of cavity resonator (301, 303) with only one electro-acoustic transducer (magneto-dynamic driver).

FIG. 3/b to FIG. 3/g show six arrangements (basic configuration systems) achieved by inversion of the phase/feeders of the electrical input signal/channel that supplies different moving/vibrating coils: Left input channel=White arrow/Right input channel=Black arrow (where the movements of the coils can be: in phase=“air suction”=external arrow/inverted phase=“air compression”=internal arrow).

SHEET 4/6

Second example in section (FIG. 4/a) of cavity resonator (407, 411, 413, 415) suitable for electro-medical use with two electro-acoustic transducers that are situated opposite one another at 180° at the two extremities of the cavity resonator. The magnetic fields of the two drivers are generated by permanent magnets/magneto-dynamic driver (417) and by (electromagnetic) coils/electro-dynamic driver (403).

Four of this type of acoustic device (“X”, “Y”, “J”, “K”) are shown (schematised) with their sonic beams (acoustic waves/harmonic frequencies) concentrated on a sliding bed in FIG. 4/b.

SHEET 5/6

Third example in section of cavity resonator (FIG. 5/a) in which the Right acoustic device has been constructed to be inversely congruent with its symmetric Left twin.

The following two electric circuits (FIGS. 5/b, 5/c) show only two different methods of connection of the two acoustic devices in FIG. 5/a to the Left/Right channels.

The last two drawings (FIGS. 5/d, 5/e) show typical industrial applications where electro-acoustic transducers (with a cavity resonator) are coupled to the “RESONATOR DEVICE AND CIRCUITS FOR 3-D DETECTION” of Patent WO 2003/079725.

SHEET 6/6

A fourth example in section of cavity resonator (FIG. 6/a) shows four drivers arranged at 90° angles to each other.

It is also possible to have several acoustic devices (and therefore audio channels) grouped together in a single position (FIG. 6/b).

### DESCRIPTION OF THE MAIN COMPONENTS OF THE ELECTRO-ACOUSTIC DEVICE ACCORDING TO THE INVENTION

1) Magnetic Circuits and Drivers

The electro-dynamic drivers must be able to magnetise and demagnetise themselves rapidly in relation to the activation/deactivation of the solenoids, therefore an economic (easy to use) material is employed like soft iron or mild steel and ferrite. To (in assist the central solenoid the centre of the driver) it may prove convenient to provide for the use of support (fixed) coils this may make the use of the ring (261), in corrugated material, superfluous.

The presence of only four support (fixed) coils may cause problems, therefore it is advisable to use a microprocessor (in order to adjust the input signals) to be connected to the coils set equidistant to each other (e.g.: 6 coils×60°=360°).

The parts that must be “transparent” to the magnetic fields can be made from austenitic stainless steel.

The permanent magnet in the magneto-dynamic drivers must generate a high magnetic field (not comparable either in precision or quality to that generated by the solenoids). The most powerful magnets available today are “sintered” metal powders, but they are extremely fragile and therefore have reduced dimensions.

Permanent magnets that are more resistant to vibrations and to shocks, as well as processing, are made from cobalt and samarium, and furthermore they only demagnetise at temperatures above 130° C.

By varying the distances between the permanent magnets a magnetic coupling is created: the greater the distance the weaker the magnetic field; considerable design alterations of these parameters can be made in relations to the use of an entrefer (soft iron core).

The hysteresis cycle in the permanent magnets must always be put into relation with the physical properties of the materials but also with their geometric shape: a ring shape has practically an almost ideal hysteresis loop.

2) Cavity Resonator

In order to be able to gather the highest amount of information possible from the electric signals that supply the moving (vibrating) coils of the device, it is necessary to control and regulate every physical parameter of the fluid (usually air) that is contained in the cavity resonator.

The temperature can be modified rapidly by using plates and junctions that exploit/utilize the “Peltier effect”; an effect which is easily controlled with microprocessors as the absorption or the production of heat depend on the direction of the current flow that goes through these metal junctions; furthermore there is linearity between cause and effect brought about by the “Peltier coefficient”.

In order to obtain a rapid variation or to stabilize pressure, it may be very useful to employ the use of micro-pumps placed on the outside of the device.

The higher internal pressures are obtained by using cavity resonators equipped with the type of drivers in FIG. 4/a, Sheet 4/6, because they do not make use of fragile and easily deformed materials as do the acoustic cones of the loudspeakers.

Temperature and pressure sensors are placed in strategic positions.

The cavity resonator corresponds to a resonating circuit in which it is not always possible to clearly distinguish the elements that carry out an inductive function to those that carry out a capacitive function. The electromagnetic field is instead mainly concentrated in proximity of the drivers, particularly in the “gap” where the moving coils vibrate. The electrostatic charges that accumulate on the small metallic caps are a consequence of the rapid movement of the fluid contained in the small vibrating cylinders of the moving coils.

Whilst designing a cavity it is important to “tune” the frequency in accordance with the (d) distance between the moving coils, therefore by increasing the distance the natural frequency of the cavity increases as the capacity reduces. An opposite effect also exists produced by the vibration of air in the sound pipes (e.g.: organ pipe), in fact there is a direct proportion between the length of the cavity (equal to half a wavelength “λ” of the fundamental frequency) and that of the wave of the generated sound and its nodal point (that assumes different positions in time due to the movement of the cylinders that are connected to the moving coils). Another method that can be used to vary the resonance frequency (f_{R}) is that of reducing the inductance by confining as much fluid as possible (normally air) into a duct with a reduced diameter (but if the opening is too small, this will nullify most of the advantages deriving from this technology).

The “core” is supported by adequate air chambers, inflated at low pressure, in order to subdue the vibrations (and not the sonic waves). An adequate mass of the “core” can increase the acoustic quality of the device.

3) Magnetic Flux and Moving/Vibrating Coils

The drivers described above produce a magnetic flux between opposite poles (North vs South) which tends to spread and disperse into the air in the centre of the “gap”, therefore the magnetic flux available to the moving coil tends to diminish drastically as the air “gap” increases.

In the presence of a positive (in phase) input signal the moving coil must be able to move away from the central solenoid (electro-dynamic driver) or from the permanent magnet (magneto-dynamic driver) as shown in FIG. 2/b (233) therefore it draws in air through the opening in the core of the driver (it draws in air from the resonator); in the presence of a negative input signal the coil must be able to draw closer to the solenoid/central magnet (235).

The core of the resonator device has the function of strengthening the sound and above all it must concentrate the energy inside the structure of the resonator, to then diffuse it towards the outside. The moving coils that are spaced out and set opposite each other, move backwards and forwards as though they were tied/linked to each other by an elastic rod that crosses through the cavity of the resonator.

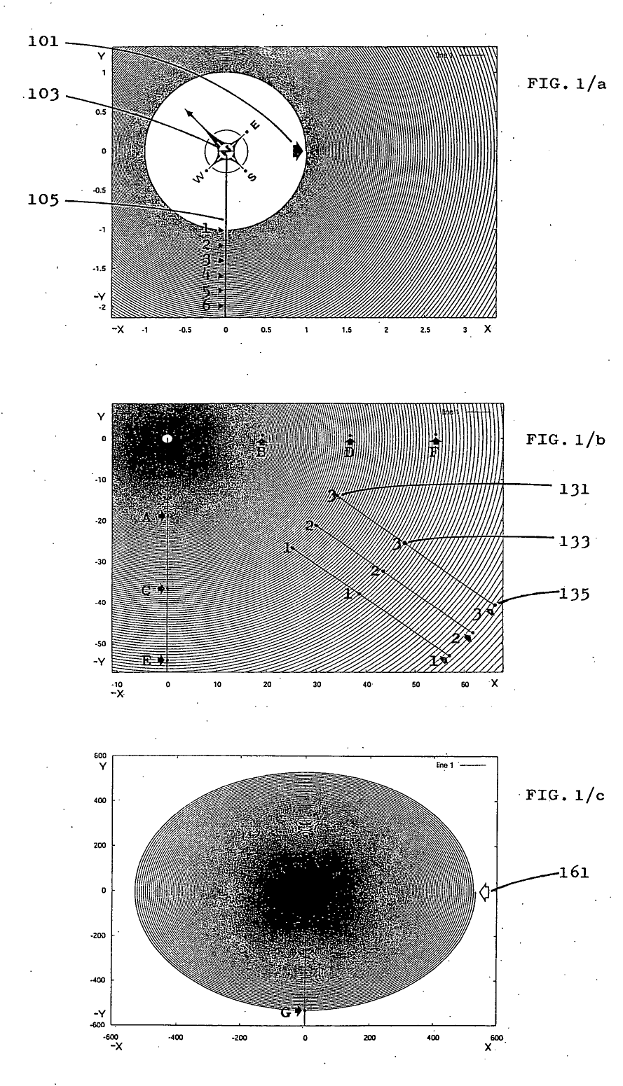

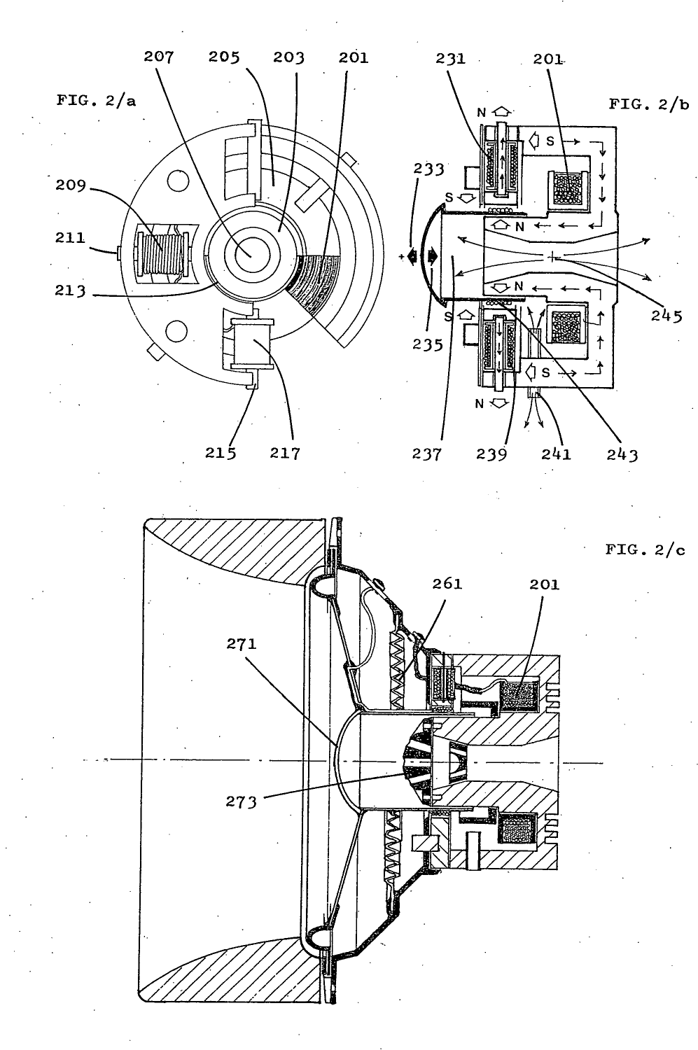

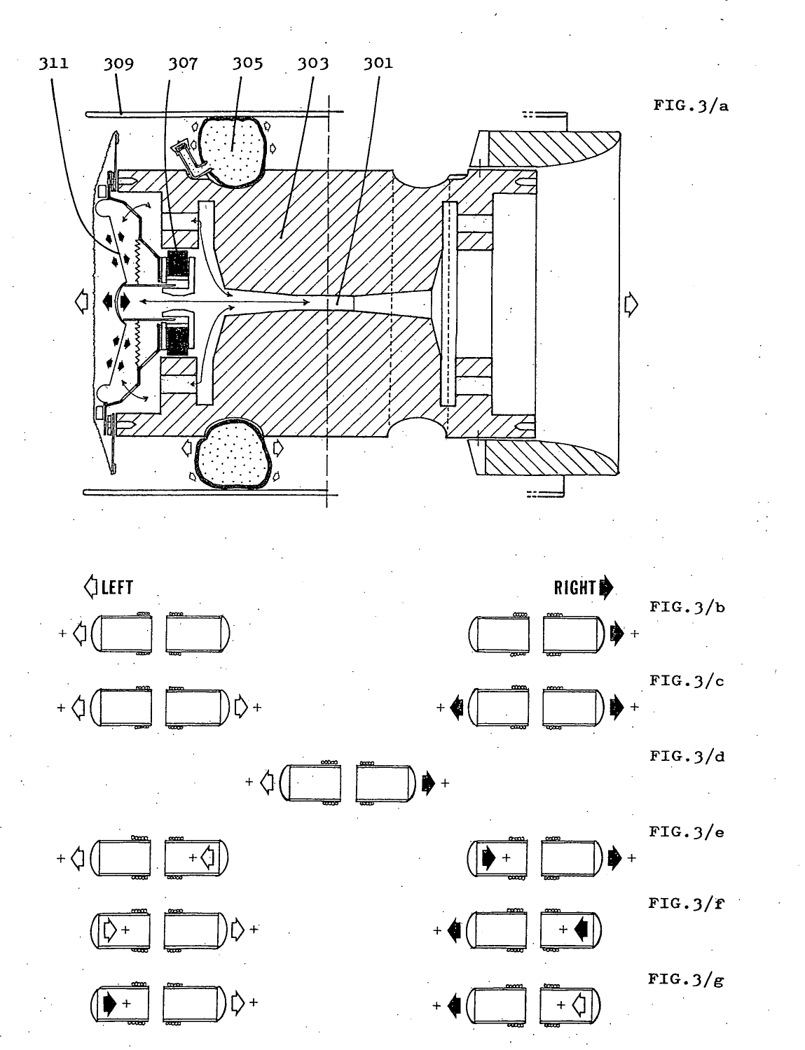

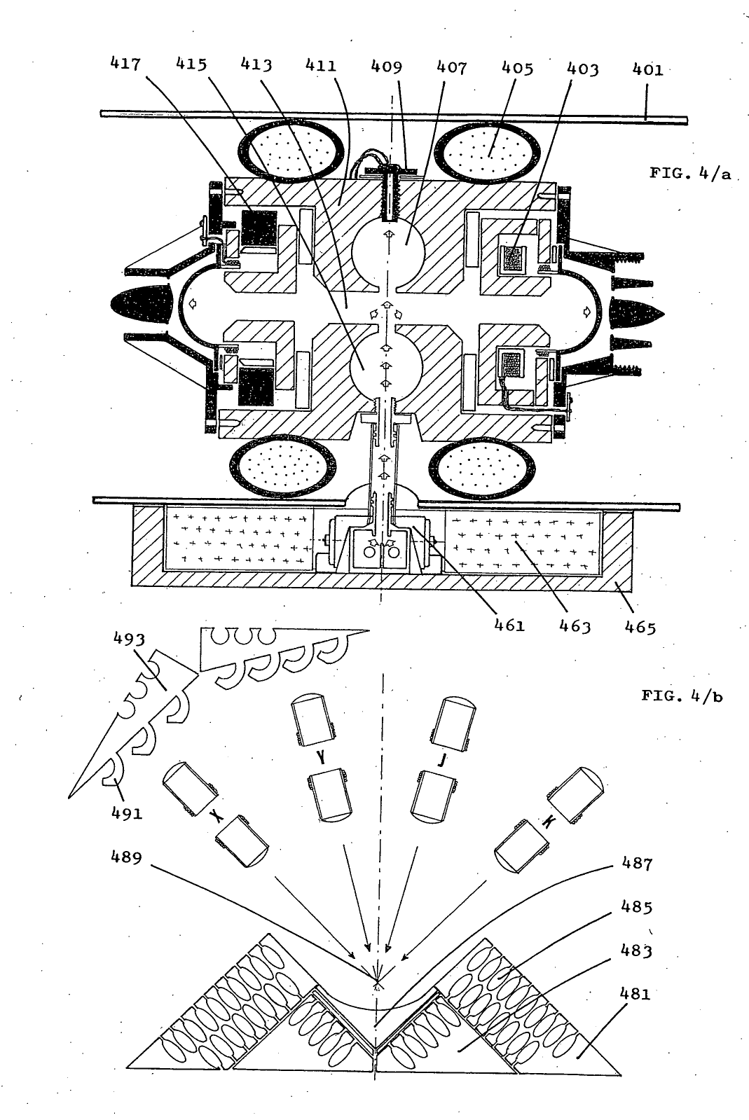

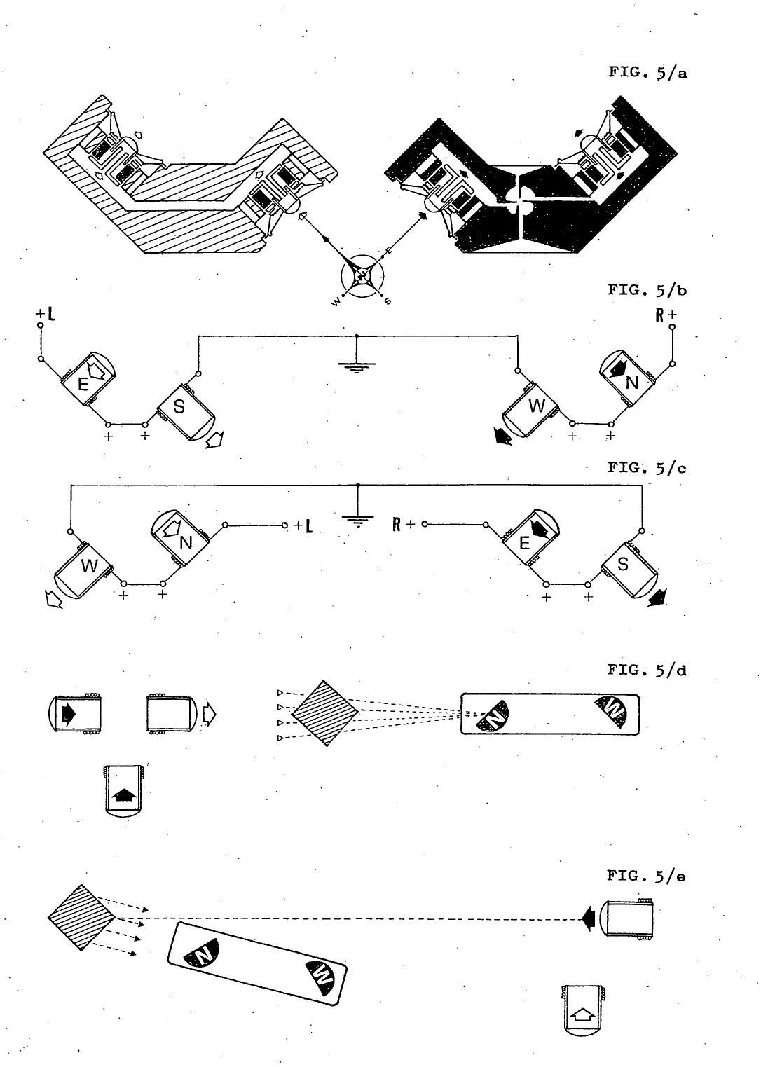

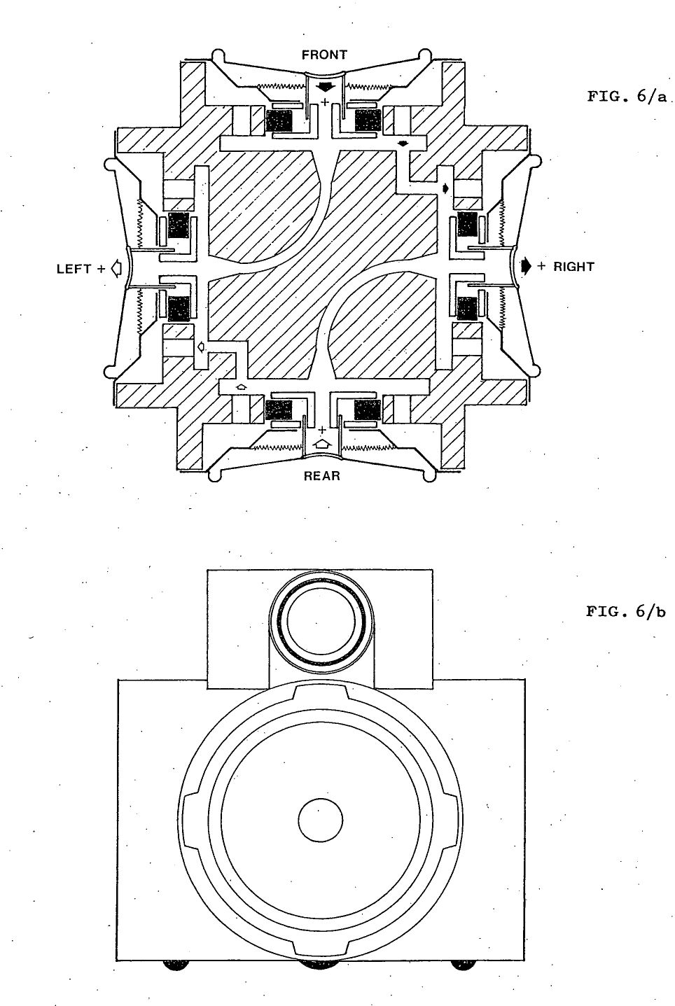

The use of two or more devices (an even amount is best) gives way to a variety of applications (see examples Sheet 3/6 from FIG. 3/b to FIG. 3/g), but a perfect solution is that of the example in FIG. 3/g, a logic of symmetry also seems to be preferable, as for example: two or four devices that are inversely congruent in shape that rotate in opposite directions until they reach angles of the same amplitude (this application is extremely interesting in the electro-medical field); or devices that are connected either electrically or arranged according to precise axial symmetry; but above all two or four devices connected between themselves and arranged according to a pattern of central symmetry, even starting from a pair of stereophonic channels).

Description of the Basic Theoretical Principles (Algorithms) of the Electro-Acoustic Device According to the Invention

The invention originates from several algorithms and it is mainly two of these that make up the object of the patent: one relative to the way that acoustic energy spreads starting from two components, the second with explicit reference to the structure and the work/function carried out by the human larynx and vocal cords. A novel equation, expressed in polar coordinates in the plane, with orderly pairs of real numbers “ρ” and “θ”, came from the first of the algorithms, which represents a particular type of logarithmical spiral:

$$\begin{matrix}ρ = {c}_{s} \cdot ( \tilde{t} + \frac{\tilde{ρ}}{{c}_{s}} ) \cdot {ⅇ}^{\frac{{c}_{s}}{\sqrt{{k}^{2} - {c}_{s}^{2}}} \cdot ( ϑ - \tilde{ϑ} )} & & where k > {c}_{s}\end{matrix} \qquad ( Formula 01 )$$

\tilde{t},\tilde{ρ},\tilde{θ} refer to a time different to “zero” taken as reference with respects to the origin “O” of the polar coordinates; from Formula 01 one gets the angles expressed in radians:

$$\begin{matrix}ϑ - \tilde{ϑ} = \frac{ln \frac{ρ}{{c}_{s} \cdot ( \tilde{t} + \frac{\tilde{ρ}}{{c}_{s}} )}}{\frac{{c}_{s}}{\sqrt{{k}^{2} - {c}_{s}^{2}}}} & ( Formula 02 ) \\ simplified in \text{:} & \\ {n}^{∘} revs = \frac{ln \frac{ρ}{\tilde{ρ}}}{2 π \frac{{c}_{s}}{k}} & ( Formula 03 )\end{matrix}$$

Formula 01 may also be simplified in this way:

$$\begin{matrix}ρ = {ρ}_{o} \cdot {ⅇ}^{\frac{{c}_{s}}{k} \cdot ( ϑ - {ϑ}_{o} )} & & valid only with k ⪢ {c}_{s}\end{matrix} \qquad ( Formula 04 )$$

This is the definition of the spiral conceived and calculated by Ramenzoni: the trajectory of a point P characterized by having a constant radial speed c (with respect to specified polar coordinates in the plane) is characterized by a constant time derivative k of the arc length along the spiral itself, with k>c. The solution to this geometric problem implies an always well defined progressive reduction of the velocity of the point P (whose anti-clockwise rotation direction is considered positive by convention). In order to carry out simulations it is necessary to have k>>c_{S}, and therefore the value of the speed of propagation of sonic energy through the medium (or chosen environment) is assigned to the c_{S} constant, while k can reach values depending on the speed of light in the medium taken as reference.

Application Prospects Derived From the Electro-acoustic Device According to the Invention (Laboratory Tests)

A) Information Theory “On the Cosmic System” [by Daniele Ramenzoni© 2004]

The theory is that of disposing of an information transmission system starting from two components. We can make the first component correspond to a vector that transmits information at the speed of light, and that has the specific characteristic of joining the transmitter to one of the many possible receivers with an ideal straight line.

The second component differentiates the transmission to each receiver depending on their positions relative to each single transmitter taken as reference.

The information proceeds along a curved trajectory (spiral) resulting in the existence of a variable angle, always slightly inferior to 90°, between this second vector and the fundamental one (the first one). The exact size of this angle allows the determination of the distance from the transmitter and the density of the information travelling on the second vector.

One of the data storage systems invented and in use is a type of spiral whose pace is always perfectly the same and this happens in such a way to make the best use out of all the space available to it on the flat support. From the need in the cosmic system for having only vectors that proceed at a constant velocity . . . , from the need of transferring information onto a “support” without capacity limits . . . , from the need of making a second vector travel on a spiral with an increasing pace . . . , one deduces that the ideal form of communication for a cosmic transmitter can only have the following equation in polar co-ordinates on the plane:

$$\begin{matrix}ρ = \tilde{ρ} \cdot {ⅇ}^{\frac{{c}_{L}}{k} \cdot ( ϑ - \tilde{ϑ} )} & & valid only with k ⪢ {c}_{L}\end{matrix} \qquad ( Formula 05 )$$

If cosmic space were infinite there would be no need to “format” it. Therefore if space is “formatted” this means there is a limit even for this supreme greatness, consequently however reasonable it may seem to believe that the space available is greater than the quantity of information that can travel through it (there are more supports than information to be stored), it appears opportune to suppose the existence of celestial bodies “erasers of information”.

Under the effect of these “erasers” of information, what initially tended towards the infinite will close in to the finite in this way allowing the information, otherwise destined to get confused and lost, to return to being useful again if it is intercepted on the path it follows before reaching its almost complete annihilation. These useful functions are synthetized by the following equation:

$$\begin{matrix}\tilde{ρ} = \frac{ρ}{{ⅇ}^{\frac{{c}_{L}}{k} \cdot ( ϑ - \tilde{ϑ} )}} - {c}_{L} \cdot \tilde{t} & & where k ⪢ {c}_{L}\end{matrix} \qquad ( Formula 06 )$$

By means of this equation disturbance noise does not prevail on the rest of the information, furthermore the information transmitted is subject to the dominion of the pace of the spiral which determines the deterioration of the signal regardless of the amount of time that has passed from leaving its origin.

If C_{L} is made to correspond to the speed of light in space, perhaps k should be considered as a velocity vector which describes a movement of information instead of matter.

If information were distributed on different planes (and not inside a single container having a precise volume) it would be information that is relative to a precise bi-dimensional ambit; and this could be a good thing because there is always the possibility of tuning in (by applying the 90° rule) on different informative planes whilst remaining in the same reception point.

B) Draft for Theory of “the Manifold Planes” [by Matteo Belli and Daniele Ramenzoni© 2004]

In cosmic space there are almost infinite intersections of planes that are very different from one another that take reference from one point of origin (e.g.: a star) or to a point of arrival (e.g.: a black hole). This would allow to speculate on a simple and useful system for measuring co-ordinates for the travelling of great distances.

The passage from one reference plane to another occurs through appropriate rotations according to the relative Euler angles and through the knowledge of the equation that describes the trajectory of each new spiral that has been intercepted. In particular the distance between the considered point and the source of the information is defined once the displacement of the 90° angle between the two components that have been intercepted on the plane that are to be taken as a new, valid, reference is known.

The information theory on the cosmic system is also applicable in practice to systems considerably reduced in size, as for example devices for electro-medical use.

Graphic Representation of the Working of the Algorithm of the Spiral Studied by Ramenzoni” (Sheet 1/6)

The three figures (FIGS. 1/a, 1/b, 1/c) show the same spiral (on different scales) in which the speed of point P is constant on the radial vector (speed c) and in which the modulus of the velocity projection of point P is also constant on the curve (speed k), and it is necessary to have k>c.

The velocity of the point is obtained from the time derivative of the position (equation of motion), and performing a further time derivative the acceleration is obtained (position, speed and acceleration are vectors, and the anti-clockwise rotation is by convention considered positive).

If speed cₛ, corresponds to the speed of the propagation of sonic energy in the air (cₛ=333.3 meters per second at the temperature of approximately +3° C.), the order of magnitude of the units and also, above all, the legibility of the graphic representations that are obtained will depend exclusively on the value of the speed of the k constant. Therefore at least two constant values should be allocated to k (in proportional ratio to one another): one necessary for the calculations, the other verified on the graphic representations (in order to make them understandable and always comparable to the calculations).

FIG. 1/a clearly shows the initial part of the spiral (indicated by the large black arrow, in 101) that would otherwise be impossible to see in the scale of FIG. 1/c, when the simulation has been interrupted at the point indicated by the large white arrow (161). In FIG. 1/a the origin, or “pole”, O is fixed by convention (103) at the centre of the four cardinal points (North, West, South, East).

With each increase of a unit of time (increments always of equal value) constant increments on the radius are produced (that is, of identical linear length); such increments are indicated with ρ₁, ρ₂, ρ₃, ρ₄, ρ₅, ρ₆ (but only the numbers without the Greek letter “rho” have been shown on the drawing).

Every increment of a round angle of point P on the spiral corresponds to a circular path with the addition of an increment, called “pace” of the spiral: in this curve the pace increases with every round angle, whilst the radial vector in proportion slows down.

This is comparable to an advancement of discrete concentric circles starting from a phase front that moves forward contemporarily performing a circular movement.

Description of Electro-dynamic Driver (Sheet 2/6)

In FIG. 2/a only the static components of the driver are shown, these are to be supplied by direct current and controlled in the best of cases by a microprocessor. The fundamental component that distinguishes this electro-dynamic device from a magneto-dynamic one is shown: the driver. This part mainly consists of the central solenoid, which is made up of innumerable spirals (coils) (201). At least two drivers similar to this must be inserted into a third fundamental organ that makes up the device: the cavity resonator (see FIG. 3/a Sheet 3/6). The drivers and the resonator indissolubly make up the “core” of the device that is the subject of this patent.

The driver of this example is made up of at least one main solenoid (201) wound around the core (203), which has a particular central opening (207) in order to obtain an alternating flow of air (245) from the moving coil (243) which makes the small central cap (271) vibrate, through its alternating movements (233 and 235).

In the air chamber under the small metallic cap (237) an accumulation of electric charges is brought about, which is to be correlated to the working of the device through the nozzles made in a particular form (273); but these parts must allow for modification.

FIG. 2/b shows the magnetic circuit (electromagnetic, if generated from one or more electric currents). The moving coil is by convention considered subject to in phase current when the cylinder and the relative protection cap receive an upright push due a positive voltage applied to the moving coil.

In the electromagnetic circuit, in FIG. 2/b, the main solenoid (201) can be boosted by at least four fixed coils (two have been sectioned in 231 and in 239), opportunely distributed on the circumference (see 209 and 217 in FIG. 2/a), that consent perfect control of the magnetic flux coming from the poles (North and South); without these support coils, that with their core (211 and 215) are able to increase and concentrate the lines of force in the desired positions, the magnetic flux would tend to disperse starting from the centre of the ring-shaped “gap” (213). All the coils, either together or independently, are supplied by direct current.

By interchanging the two supply terminals of all the coils (of the central ones, and of those placed on the circumference of the ring-shaped “gap”) all the North and South polarities indicated in the electromagnetic circuit (FIG. 2/b) are inverted, the positive movement of the cap is also inverted (233), and this will no longer correspond to the expansion phase but to the compression phase (235). These multiple regulation modes are impossible to obtain with the permanent magnets that make up the magneto-dynamic drivers.

FIG. 2/c shows a cross-section of two fundamental parts of the device: driver and acoustic radiator.

Description of Several Preferred Arrangements of the Electro-acoustic Device

W) In Cybernetic Apparatus (Sheet 3/6)

In FIG. 3/a the “core” (303) of the device is shown inserted into a containing “shell” (309). This drawing shows a typical example of a cavity resonator (301) that is also able to emulate the typical characteristics of human phonation; in order to obtain this result the “core” should always be isolated by air-chambers that are inflated at low pressure (305) and protected inside a containing shell. In this example the left driver (307) is of the magneto-dynamic type and this allows for the creation of apparatus of even the smallest dimensions (with high sound output). This type of driver provides medium-low frequencies in relation to the external diameter of the vibrating cone (311).

The imitation of the human voice, even for its directionality, requires the use of two devices built mirror opposite to each other (with axial symmetry), furthermore the four moving (vibrating) coils (two per each of the devices of the type shown in FIG. 3/a) must be supplied according to the electrical scheme described in FIG. 3/g.

Therefore two examples of this electro-dynamic driver, complete with acoustic radiator, illustrated in FIG. 2/c (Sheet 2/6), linked together by a cavity resonator (303) make up one of the two parts (mirror opposite through axial symmetry) that are necessary for a highly accurate reproduction of the effect that the larynx creates in the trachea through the movement of four membranous strands said “vocal cords”. These elastic membranous strands are mirroring with each other as they are arranged two on the left and two on the right with respects to the larynx and human body. For a precise description of the effects produced by the magneto-dynamic circuit on the vibrating organ (constructed starting from the moving coils) all the parts that are superfluous to this type of graphic representation, which is valid for both electro-dynamic and magneto-dynamic drivers, have been eliminated from the drawings (of FIGS. 3/b, 3/c, 3/d, 3/e, 3/f, 3/g).

The examples from FIG. 3/b to FIG. 3/f show that one single device can imitate any other system existing today, with the added advantage that the annoying effect of the “presence” of loudspeakers will no longer exist, this is also influenced by the type of material used.

Furthermore to show that a single two-driver device (example in FIG. 3/d) can be considered as part of an expandable diffusion system according to application needs, the hypothesis of also varying the polarity of the power supply to each pair according to its corresponding mirroring twin has been taken into consideration (examples FIGS. 3/b-c-d-e-f-g).

In order of importance (from one to six stars):

FIG. 3/b: Simulates a traditional stereophonic system, but in this case the sounds reproduced are not conditioned by the construction materials (*).

FIG. 3/c: Simulates traditional stereophony, in fact the spatial reproduction of the sounds still depends upon the position of the listener (**).

FIG. 3/d: Stereophonic effect reproduced with clear improvement of the spatiality with respects to the preceding case (***).

FIG. 3/e: Excellent spatiality but mainly diffused towards the exterior (****)

FIG. 3/f: Perfect spatial reproduction from any listening position both in “stereo” and “multi-channel”, always using one transducer per channel (*****).

FIG. 3/g: Almost always perfect tri-dimensional representation (******) even starting from a single device but connected to two “stereophonic” channels, with absolutely perfect reproduction from multi-channel systems (by sending two different channels to each device). This example is the most important because each of the (mirroring) pairs reproduce the working principles of the two tubes set opposite each other of the Helmholtz resonator: therefore only from this type of configuration (either taken singularly or set in a mirroring two-channel system as in this example) is the diffusion of tri-dimensional sound obtained starting from each cavity resonator.

X) For Electro-medical Applications (Sheet 4/6)

FIG. 4/a: Device suitable for generating even high frequencies because the diffusion cone has been eliminated to leave space for a special vibrating protection cap which is connected to a corresponding vibrating coil that can be supplied by either magneto-dynamic drivers (417) or electro-dynamic ones (403) even in the presence of a pump (461), which compresses the fluid in the cavities of the resonator. This pump can be controlled by a microprocessor by means of one or more pressure and temperature sensors (illustrated in the drawing with a single control device, in 409).

FIG. 4/b: Shows a schematised plan of a typical surgery equipped for therapy with both concentrated and diffused sound waves; in this example all four devices (similar to that shown in FIG. 4/a) concentrate the wave beam that they have generated in one single point (489), in this way creating an application for therapeutic purposes; the electro-medical equipment is completed by an electrically commanded bed (487), and by special sound-absorbent or reverberating panels.

In fact, with complex apparatus that employ more than two cavity resonators, components such as materials with active sound-absorbent shape are indispensable (493), with numerous vibrating absorbers/attenuators (491) appropriately dimensioned with respect to the lengths of the waves used, also the materials with reverberating shape (481 and 483) for their internal cavities (485) that are similar in shape (with different dimensions) to those of the cavity resonators to which they will be applied (inside transmitters/concentrators of sound/sonic waves).

FIG. 4/a shows an electro-medical device which is particularly suitable for containing; very particular and elaborate resonating cavities, internal temperature and pressure control devices and sensors for measuring these parameters in relation to the perfect air-tight closure that is obtained with the moving coils without the vibrating cone.

Y) In the Civil and Industrial Acoustics Field (Sheet 5/6)

FIG. 5/a shows an extremely sophisticated listening device which is the most accurate available today for reproducing sounds of any nature recorded with the transducer for tri-dimensional reception of sound/sonic waves described and cited in the international patent “RESONATOR DEVICE AND ASSOCIATED CIRCUITS” (published with number WO 2003/079725 in the inventor's name).

This same pair of sound diffusers (mirroring through axial symmetry) can be connected differently to the output of the amplifiers as shown in FIG. 5/b for concentrating sounds towards two central sound fields (indicated as Front and Rear) or, as shown in FIG. 5/c, diffusing them in every direction starting from any desired position without varying the (electric/electronic) internal circuits. FIG. 5/d shows, in a very schematic way, an industrial application for the detection and/or testing of materials, even of large dimensions, these should be placed or made to pass through a pre-fixed area (having a precise distance according to the wavelength) between the transmitter and the receiver.

In FIG. 5/e another possible configuration is described achieved by coupling with the receiver of WO 2003/079725 (FIG. 12 Sheet 5/5 of that patent), where that receiver is inserted between the transmitter and the objects to be tested/analysed (which could be moving).

Z) Design/Plan Variations of the Electro-acoustic Device According to the Invention (Sheet 6/6)

The example in FIG. 6/a highlights the fact that two acoustic radiators that make up a pair can form an exact angle of 90° employing a cavity resonator suitable for that purpose.

This type of solution eliminates any type of defect that occurs in all other low frequency listening equipment on the market today, whilst working with f<300 Hz.

Furthermore this example shows in an unmistakable way the advantage of a tower arrangement, one above the other, of several sound diffusion devices, as illustrated in FIG. 6/b, without losing listening quality.

Conclusions

In the case of old monophonic transmissions/recordings, as in more recent stereophonic or multi-channel ones, tri-dimensional listening is always guaranteed, even if there is only one transducer, with any of the devices described in Sheets from 3/6 to 6/6.

The multi-channel systems above all seem to be the most heavily penalized by the comparison with this revolutionary technology (in particular see relative drawings and descriptions on Sheet 3/6).

These are the acoustic parameters that have been taken as reference: perfect sound, dynamics, clearness, recognizability, realistic and correct positioning of the source, etc., together with the extraordinary freedom on behalf of the listener of being able to listen to any type of sound from any desired position (the effect is so realistic that it leads the listener to believe that the acoustic device of this patent is not switched on at all but that the sound is coming from a live source).

For impeccable listening of sound recordings carried out with 3-D receivers shown in patent WO 2003/079725 (Sheet 1/5 and 2/5 of that patent), reference can be made to diffusers that are mirror opposite through axial symmetry (as in FIG. 5/a Sheet 5/6) that achieve a tangible increase in sound performance, with respects to the traditional types. This acoustic device allows for several types of electric connection with the amplifiers and also various position possibilities of the diffusers in the environment: in the two examples in FIG. 5/b and 5/c the electric connection inside each of the diffusers has remained unchanged but the Left=L and Right=R channels have been connected in different ways, in the first case the best solution for the listener is to position himself/herself between the diffusers (scheme in FIG. 5/b) or, in the second case, the best solution for the listener is to position himself/herself outside the area between the two diffusers (scheme in FIG. 5/c).

For some diffusers the use of the containing “shell” or “tube” illustrated in FIG. 3/a Sheet 3/6 (309) and FIG. 4/a Sheet 4/6 (401) is not necessary. With the addition of this containing body the cavity resonator is able to vibrate freely because it is exclusively supported by the air chambers (305 and 405) that have been inflated (at low pressure); but other types of shock absorbers may also be used.

### INDUSTRIAL APPLICABILITY

The extraordinary characteristics of the device described above make it particularly suitable for working as the main component in electro-medical equipment. Remarkable cuts on construction costs can be obtained by using permanent magnets.

1. The acoustic device (and its electric/electronic circuits) operates as an injector of acoustic/sonic energy, and as a generator of electromechanical resonance, suitable for use in cybernetics, therapeutic and laboratory uses, able to transmit/concentrate/diffuse tri-dimensional sound/signal with extreme precision in the atmosphere and in fluids as also in the human body (tri-dimensionality also comes from the main harmonic frequencies of the signal to be transmitted), for the reproduction of various tri-dimensional sound fields that are identical to the original ones, or for generating completely new ones, always compatible with the binaural human perception of sound, with the function of emulating and boosting of several characteristics of the human voice (both male and female), according to the required use, as the enclosed drawings/examples show, in accordance with the present invention, characterized by the fact that it contains a modular unit for the transmission of energy (infrasonic, sonic and ultrasonic waves and signals), said “modular unit” is suitable for linking to another identical or symmetrical modular unit in which said “symmetrical modular unit” must have an inversion in the polarity of the power supply (by simply inverting the voltage feeders, positive and negative pole, of the power supply of the fixed solenoid/s) and/or an inversion in the phase of the input signals (by simply inverting the two feeders of the electrical input signal), and/or an inversion of parity in the construction scheme (that consists in a mirror reflection with 180° rotation with respects to all the forms, angles and dimensions of the reference unit), and/or inversely congruent angles in the construction scheme (angles with the same width and with different spin/revolution with respects to the original angles of the reference unit), and/or an axial or central symmetry with respects to the parameters of the reference unit, and many other similar schemes; this electromechanical device may also be used to make up cybernetic/laboratory/electro-medical equipment, in which each of the said “modular units” comprises of at least one cavity resonator (formed by a hollow resonating mass or hollow resonating body) having one or more openings at the entrance extremities and one or more openings at the opposite exit extremities (that determine the direction/way of sound transmission); said “hollow resonating body” (constructed according to the various application needs) also contains a fluid with stabilized temperature and pressure; said “entrance extremities” and said “exit extremities” can also be interchanged (even with precise frequencies, e.g. with ultrasound frequency); said “modular unit” for signals/waves/harmonic frequencies transmission, with its hollow resonating body, also contains drivers with magnetic field generators such as, for example, permanent magnets (said magneto-dynamic drivers), solenoids and/or coils and/or windings and any other type of inductive components (said electro-dynamic drivers) and/or capacitive components; it is also possible to equip these modular units with both permanent magnets and electric magnets together (said mixed dynamic drivers); these electro-acoustic transducers, with hollow cores at the connection points to the cavities of the resonators, have magnetic fields with force lines travelling in the same way or in the opposite way, or force lines with opposite ways generated by moving/vibrating coils placed opposite each other with opposite input signal phases; in the cavity resonator the sound waves and their harmonic frequencies are recomposed and find their way to the point of origin (this is obtained with the main harmonic frequencies, for example the 2^{nd} and 3^{rd} harmonic frequencies that are produced by sound sources) through two or more openings that are diametrically opposite each other in this (electro-) acoustic device (see claim 20).

2. The acoustic device, according to claim 1, is characterized by the fact that, in at least one single cavity resonator, the sound wave/harmonic frequency is diffused from (one or more) said “openings” at the “entrance extremity” to (one or more) said “openings” at the “exit extremity” (or vice-versa), because of the effect of the magnetic fields with all force lines travelling in the same way, or differently because of the magnetic fields with force lines travelling in opposite ways generated by moving/vibrating coils placed opposite each other with opposite input signal phases; said “input signals”, if coming from (two or more) different channels (i.e.: each pair of channels can be Left/Right and Front/Rear, or Front/Left and Rear/Right, and so on) must be connected in this way: each channel of each pair of channels is connected to each coil of each pair of coils; the coils are set opposite each other at 180° (or at 90° where the cavities have this same arrangement, and so on) being placed at the opposite extremities (entrance openings and exit openings) to the cavity resonators.

3. The acoustic device, according to claim 1, characterized by the fact that it has means for generating magnetic fields inside the body/structure of said “cavity resonator” in correspondence with the (two or more) “openings” at the opposite extremities, constituted of magneto-dynamic drivers which are formed by permanent magnets (electro-acoustic transducers, as the more common loudspeakers) or by electro-dynamic drivers formed mainly of solenoids which are supplied by either DC or impulse current (advantageously each solenoid can be adjusted either manually or automatically by means of its own power supply), but also are formed by mixed dynamic drivers (both: permanent magnets and electric magnets together), and each of the said drivers having at least one hollow core for each connection point to the cavity resonator; allowing the said moving (vibrating) coils, that are situated near the openings at the opposite extremities of the cavity resonator, to remain in communication constantly with each other at the distances established during design (where this distance represents one of the fundamental parameters for the correct assembly of the cavity resonator because of the strong correlation it has with the signal to be transmitted and its main harmonic frequencies).

4. The acoustic device, according to claim 1, characterized by the fact that it contains means for adequate power supply either through DC or through impulses to all the solenoids, and to all the coils that constitute the fixed parts of the electro-dynamic drivers (included in this means of supply are the connectors and distributors of electrical links, the electric conductors that supply sufficient power to all the control systems); that besides the device also make up (in cases where their use is required) electronic circuits equipped with microprocessors and similar, that are necessary to adjust and stabilize temperature, pressure and any other parameter regarding the fluid (usually air, which could be hermetically sealed inside the cavity resonator) contained and circulating in the various cavities of the resonator and in the drivers, and all the wires that transport, distribute and allow selection (by means of selection keys/buttons, or by means of a remote/radio-control) of the correct signals to be sent towards each moving (vibrating) coil from all the signals coming from various sources (including multi-channel).

5. The acoustic device, according to claim 1, characterized by the fact that it includes acoustic radiators appropriately dimensioned/sized (where necessary, used even with the sound-absorbing or reverberating panels) and adjustment systems for each of the electrical components inside the drivers, suitable for transforming into vibrations (inside the cavity resonator) a selected percentage of acoustic energy (harmonic frequencies) so as to make the points of maximum amplitude (positive or negative) of the said “acoustic waves” coincide with the precisely determined pre-fixed zones concerned (this is obtained by adjusting the distance between transmitter and target depending on the wavelength of the harmonic series to be used) on pre-fixed targets to be hit and to be made to resound, in doing so a sound analysis is also made of the objects in question (dispersing or concentrating precise frequencies/harmonic frequencies in the concerned areas/points).

6. The acoustic device, according to claim 1, characterized by the fact that the said “cavity” of the said at least one “resonator” is made up of materials that absorb or reverberate acoustic energy and harmonic frequencies.

7. The acoustic device, according to claim 1, characterized by the fact that the said “transducer system” comprises two or more drivers (generators of magnetic fields) inside the cavity resonator that make up a single hermetically sealed body; each driver is coupled to an acoustic radiator whose purpose is to concentrate (in a prefixed point) or to diffuse (in any direction into the air, or into fluids/liquids, as also into the human body, for diagnostic and therapeutic purposes) infra-sounds, sounds and ultrasounds even as impulses or shock waves, also for material analysis (or in order to find contaminating substances and for any other similar application); each said “electro-dynamic driver” (supplied with DC) or “magneto-dynamic driver” (containing permanent magnets) includes one or more solenoids (able to generate a magnetic field/flow) and at least one moving coil that has a hollow perforated core (supplied with electric input signal which will be transformed into mechanical energy and then into acoustic vibrations, harmonic frequencies, air movements modulated in frequency and intensity); each perforated hollow core is subject to a magnetic field H_{S} generated by at least one solenoid (its section is A_{S} and its length is L_{S}), each solenoid is supplied either by DC or impulse current according to pre-fixed combinations with regards to the direction of the current; during the transformation of electric energy into acoustic energy (and indirectly in consequence, the transformation into mechanical energy takes place) where the moving coils transfer the main part of their vibrating energy to the said “fluid” and/or “air” which is sucked or compressed through the holes of the core towards the intermediate central point between the said two or more drivers, the acoustic energy is concentrated in a said “starting point” from which it moves off towards an adjustable or pre-fixed corresponding “arrival point”.

8. The acoustic device, according to claim 1, characterized by the fact that it forms a modular unit (with two or more transducer systems) in order to enable the activation of the widest range of functions according to application needs: one transducer system can be coupled to at least one other identical unit; or with one having inversely congruent shape and circuits to it (inverse angles with the same amplitude); or one mirroring to it in shape and circuits through axial symmetry; or even one having shape and circuits in exact ratio through central symmetry.

9. The acoustic device, according to claim 1, characterized by the fact that said at least two “transducer systems” can be placed anywhere in the listening environment/surroundings, and the drivers (in its simplest form each transducer system corresponds one pair of drivers) are built/fixed physically and electrically into each transducer system in such a way in order to highlight particular types of symmetries in the structural designs (e.g. from the top view of four drivers=two opposite transducer systems: mutually mirroring transducers with inversely congruent angles; or inverse angles with the same amplitude; or axial symmetry between two opposite transducer systems; or also non-mirroring transducers, with central symmetry, same length, opposite direction and spin).

10. The acoustic device, according to claim 1, characterized by the fact that said “transducer systems” (in its simplest form one transducer system corresponds to one cavity resonator equipped with one pair of drivers) are placed in positions that are susceptible to be varied in order to allow the said acoustic device to produce effects like a traditional monophonic, or stereophonic, or holophonic, or multi-channel, or “Ciberphonia®” arrangement by simply changing the spatial positions of each pair of transducer systems, and/or by simply changing some of the electric polarity in the power supplied to the drivers, and/or by simply changing the phase/polarity of some of the output signal that connects the amplifier (or the signal generator) to each driver (electro/magneto-dynamic driver) of each transducer system.

11. The acoustic device, according to claim 7, characterized by the fact that the separating distance between the said “two drivers” in a single device can be between a minimum of 0.1 cm (as in the case of headphones for 3-D listening and applications that require reduced dimensions) and a maximum of 334 cm (also in the form of elongated tubes for the listening of tri-dimensional sound fields and harmonic frequencies that have very long wavelengths).

12. The acoustic device, according to claim 1, characterized by the fact that the pressure inside the cavity resonator (not inside the air chambers) is equal to, lower or higher than the atmosphere pressure (the temperature being between −25° C. and +70° C.).

13. The acoustic device, according to claim 1, characterized by the fact that it includes preamplifiers connected to said “transducers” (also microphone preamplifiers) and amplifiers that are provided with separate DC low voltage feeders connected to an equal number of supply apparatuses, each one is connected to a single channel (therefore they do not have an electric ground potential between them), which precisely guarantees a perfect display/transmission of tri-dimensional sound fields/signals, in this way allowing said acoustic devices to influence, through stimulations with prefixed wavelengths (main harmonic frequencies, pure sounds) the brainwaves/cells of a human subject in order to produce beneficial and therapeutic effects on the brain, human tissues and living human cells that are affected by serious illnesses.

14. The acoustic device, according to claim 1, characterized by the fact that said “transducers” are miniature transducers, suitable for fitting inside recorders/players/computers, or connected to recorders/players/computers or for the hearing/viewing of (solid state) records, radio programmes, satellite programmes, TV programmes (for example through standard VHS, CD, DVD, video CD, DAT, CF memory, Microdrive cards, and so on) and any other present or future audio-visual equipment.

15. The acoustic device, according to claim 1, characterized by the fact that it can be inserted into armchairs, sofas, beds, and other furnishings to transmit or listen to signals, noises, sounds, the human voice, music and any other type of sound (sound field) in a tri-dimensional form.

16. The acoustic device, according to claim 1, characterized by the fact that said “magnetic field generators” also include drivers with permanent magnets.

17. The acoustic device, according to claim 1, characterized by the fact that said “electro-acoustic drivers” (electro-dynamic driver or magneto-dynamic driver) are connected to each other either opposite one another on the same axis or at equal angles on the plane according to the number of drivers required, each one pointing towards a precise cardinal point, in which the Left transducer is made to be exactly mirror opposite to the one placed on the Right (Right transducer).

18. The acoustic device, according to claim 1, characterized by the fact that said “electro-acoustic devices” (electro-dynamic driver or magneto-dynamic driver) have drivers set at 90° between one another inside a single cavity resonator rather than being mirror opposite at 180°.

19. The acoustic device, according to claim 1, characterized by the fact that it is designed starting from several algorithms and it is mainly two of these that make up the object of the patent, one with explicit reference to the structure and the work/function carried out by the human larynx and vocal cords, and the second relative to the way that acoustic/sound energy spreads starting from two components, based on the following novel equation and/or any variation of its parameters
$$\begin{matrix}ρ = {c}_{s} \cdot ( \tilde{t} + \frac{\tilde{ρ}}{{c}_{s}} ) \cdot {ⅇ}^{\frac{{c}_{s}}{\sqrt{{k}^{2} - {c}_{s}^{2}}} \cdot ( ϑ - \tilde{ϑ} )} & & where k > {c}_{s}\end{matrix} \qquad ( Formula 01 )$$
where such equation defines/represents a particular type of spiral (Ramenzoni logarithmical spiral) expressed in polar coordinates in the plane, with orderly pairs of real numbers “ρ” and “θ”: the trajectory of a point P is described characterized by having a constant radial speed c (with respect to specified polar coordinates in the plane) and is characterized by a constant time derivative k of the arc length along the spiral itself, with k>c, in which the solution to this geometric problem implies an always well defined progressive reduction of the velocity of the point P; the velocity of the point is obtained from the time derivative of the position (equation of motion), and performing a further time derivative the acceleration is obtained (position, speed and acceleration are vectors, and the anti-clockwise rotation is by convention considered positive).

20. The acoustic device, according to claim 1, characterized by the fact of having the lines of force of the magnetic fields (generated by two or more drivers) all oriented in the same direction and that all the spatial arrangements of the speakers/transducers that the system allows, make up a cybernetic apparatus for the exact reproduction of (various) tri-dimensional sound fields that are identical to the original ones (or for generating completely new ones, always compatible with the binaural human perception of sound) where the cavity resonator works like a Helmholtz resonator but in a contrary way: if in the Helmholtz resonator the sound follows a precise route through the two openings of the bulb/sphere (the receiver) in order to reach the ear, with the inverse procedure in the inventive device (the transmitter) the sound is recomposed in the cavity resonator and goes in the opposite direction (in “reverse play”, like in cine/video editing: starting from the end-point to reach the beginning point) and finds its way to reach the point of origin (to recreate the original sound source) outside the device (by the interaction of the main harmonic frequencies with the two or more openings that in this case are diametrically opposite each other).

21. The acoustic transducer, according to claim 1, characterized by the fact that in electro-medical applications and in complex apparatus that employ more than two cavity resonators other devices are indispensable such as active sound absorbent lining, that have numerous appropriately dimensioned shapes with sound absorbing function and frequency attenuation function (through vibrations) depending on the wavelengths used (harmonic frequencies), and devices with reverberating shape, with internal cavities of similar form to those of the cavity resonators (also with different dimension/scale: e.g. the wavelength of 2^{nd} or 3^{rd} harmonics) with which they are destined to work; in the case that these panels/devices are positioned in proximity of a bed (for electro-medical applications) they should reverberate at the same frequencies produced by the transducers, whilst the panels/devices positioned on the walls/ceiling (near the cavity resonators), have the function of intercepting and dispersing the sound pressure/energy.
